(19) United States
(12) Patent Application Publication
(10) Pub. No.: US 2009/0193428 A1
(43) Pub. Date: Jul. 30, 2009

(54) Systems and Methods for Server Load Balancing

(75) Inventors: Stevin J Dalberg, Kirkland, WA (US); Lin A Nease, Granite Bay, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Ft. Collins, CO (US)

(21) Appl. No.: 12/019,673

(22) Filed: Jan. 25, 2008

(51) Int. Cl. G06F 9/46

(52) U.S. Cl. 718/105

(57) ABSTRACT

In one embodiment a system and a method relate to generating a server load balancing algorithm configured to distribute workload across multiple application servers, publishing the server load balancing algorithm to switches of the network, and the switches applying the server load balancing algorithm to received network packets to determine how to distribute the network packets among the multiple application servers.

### BACKGROUND

Server load balancing is a method of distributing workload across a number of servers in order to increase maximum throughput, efficiency, and reliability. Currently, server load balancing is typically performed using a server-side process or using network access translation (NAT).

In server-side load balancing, all network traffic is sent to each application server of a group, normally using level 2 (L2) hubs or a multicast media access control (MAC) address for the group. Each server therefore receives each network packet and individually determines whether or not it should process the packet relative to an agreed upon algorithm. Although effective, such a process is inefficient because each server must make a determination as to each network packet, thereby expending computational resources that could otherwise be used to process client requests.

In NAT, a specialized switch is used to intercept and examine all network traffic and make real-time decisions as to where the traffic should be directed based upon the current states of each application server of the group. Although such a solution is also effective, it requires relatively complex and expensive equipment that must be managed and maintained by a skilled administrator. Therefore, NAT may be undesirable for smaller systems that could be served by less complex and less expensive solutions. Furthermore, due to the examinations and computations performed by the specialized switch, there can be latency issues and performance loss when NAT is used.

### BRIEF DESCRIPTION OF THE DRAWINGS

The components in the drawings are not necessarily to scale, emphasis instead being placed upon clearly illustrating the principles of the present disclosure. In the drawings, like reference numerals designate corresponding parts throughout the several views.

FIG. 1 is block diagram of an embodiment of a network configured to perform server load balancing.

FIG. 2 is block diagram of an embodiment of a master server shown in FIG. 1.

FIG. 3 is a block diagram of an embodiment of a master switch shown in FIG. 1.

FIG. 4 is a flow diagram that illustrates an embodiment of a method for server load balancing.

FIG. 5 is a block diagram of the network of FIG. 1, illustrating delivery of a network packet to an application server using the server load balancing method described in relation to FIG. 4.

FIG. 6 is a flow diagram that illustrates an embodiment of operation of a server load balancing controller of the master server of FIG. 2.

FIG. 7 is a flow diagram that illustrates an embodiment of operation of a server load balancing controller of the master switch of FIG. 3.

FIG. 8 is a flow diagram that illustrates an embodiment of a switch performing server load balancing.

### DETAILED DESCRIPTION

As described above, current methods for server load balancing can be undesirable due to their inefficiency and/or their complexity. As described herein, however, server load balancing can be performed efficiently with relatively low system complexity when the server load balancing is performed by switches of the network. In some embodiments described in the following, each switch of a network determines where to send network packets using an algorithm that takes into account the availability of the application servers of a group. In some embodiments, the algorithm is a relatively simple algorithm that is used to forward packets in a randomized manner such that, over time, an approximately equal amount of workload is distributed among each of the servers of the group.

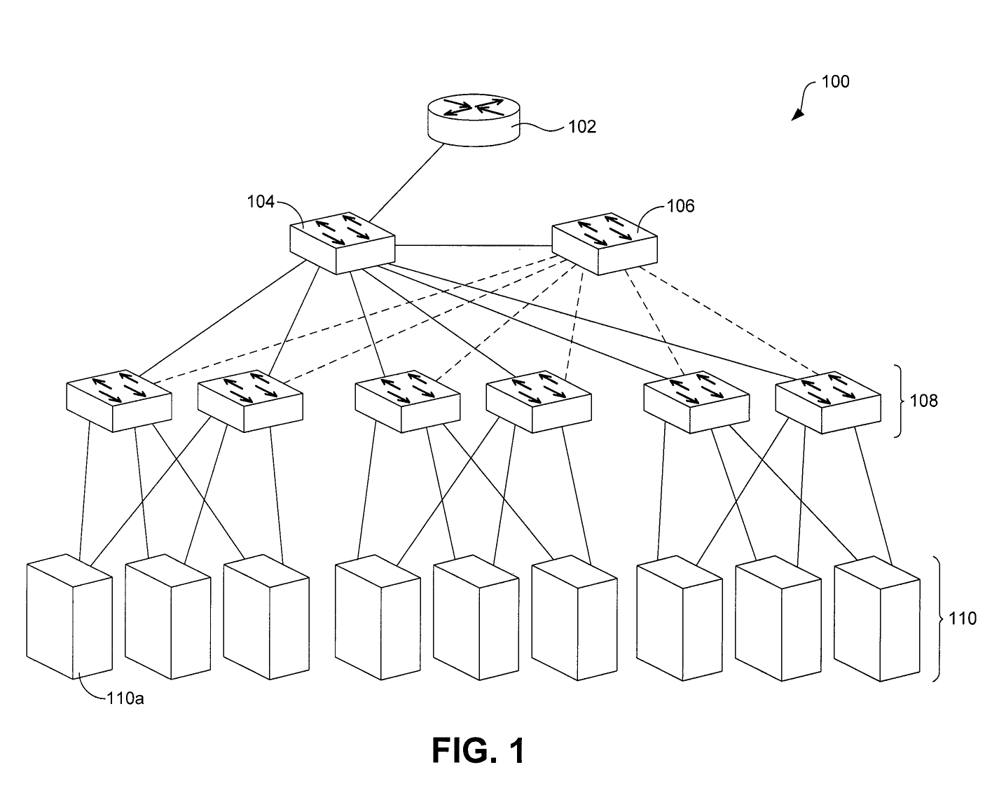

Referring now to the drawings, in which like numerals indicate corresponding parts throughout the several views, FIG. 1 illustrates an example network 100 in which server load balancing of the type described above is performed. As indicated in FIG. 1, the network 100 comprises a router 102 that routes network packets to and from a master switch 104. By way of example, the router 102 can be coupled to a further network (not shown), such as a wide area network (WAN) that may comprise part of the Internet. As described in greater detail below, the master switch 104 exercises control over the server load balancing process. In the embodiment of FIG. 1, the master switch 104 is linked to a backup master switch 106 that can act in the capacity of the master switch should the master switch 104 become unavailable.

The master switch 104 is linked to a plurality of access switches 108. In the embodiment shown in FIG. 1, the master switch 104 is linked to each of the access switches 108 of the network 100. As is also shown in FIG. 1, the backup master switch 106 is likewise linked to each of the access switches 108, although the ports of the backup master switch can be blocked (as indicated by dashed lines) as long as the master switch 104 continues to operate.

Each of the access switches 108 is linked to multiple application servers 110 that process client requests. In the embodiment of FIG. 1, each access switch 108 is linked to three application servers 110 in a manner in which each application server is linked to two different access switches. In at least some embodiments, one of the application servers 110, server 110a in this example, acts in the capacity of a master server. Like the master switch 104, the master server 110a, when provided, exercises control over the server load balancing process, as described in greater detail below.

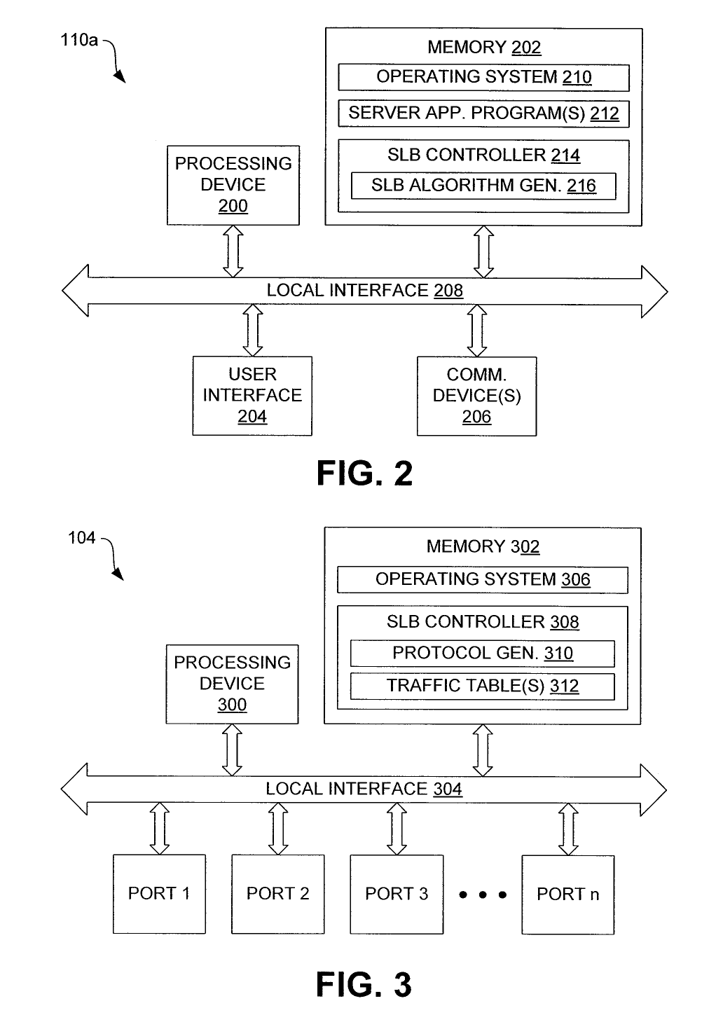

FIG. 2 is a block diagram illustrating an example architecture for the master server 110a. As indicated in FIG. 2, the master server 110a generally comprises a processing device 200, memory 202, a user interface 204, and at least one communication device 206, each of which is connected to a local interface 208.

The processing device 200 comprises a central processing unit (CPU) or a semiconductor-based microprocessor. The memory 202 includes any one of a combination of volatile memory elements (e.g., RAM) and nonvolatile memory elements (e.g., hard disk, ROM, tape, etc.). The user interface 204 comprises the components with which a user, for example a network administrator, interacts with the master server 110a. The user interface 204 can comprise, for example, a keyboard, mouse, and a display, such as a cathode ray tube (CRT) or liquid crystal display (LCD) monitor. The one or more communication devices 206 are configured to facilitate communications with other devices over the network 100 and can include one or more network communication components, such as a network (e.g., Ethernet) card, wireless interface, and the like.

The memory 202 comprises various programs including an operating system 210, one or more server application programs 212, and a server load balancing (SLB) controller 214. The operating system 210 controls the execution of other programs and provides scheduling, input-output control, file and data management, memory management, and communication control and related services. The server application programs 212 comprise the one or more programs that respond to client requests and return or serve data responsive to those requests. Therefore, the server application programs 212 comprise the logic that provides the “server” functionality during established client-server sessions. It is noted that each of the other application servers 110 (FIG. 1) can comprise similar or the same server application programs 212. It is further noted that, although the application server programs 212 are shown as being resident within the master server 110a, in some embodiments the master server may not act in the capacity of an application server, in which case the memory 202 can exclude the server application programs.

As its name suggests, the SLB controller 214 is configured to exercise control over server load balancing. As described in greater detail below, the SLB controller 214, when provided, can collect information as to the availability of the other application servers 110 and use that information to generate server load balancing algorithms, for example using an SLB algorithm generator 216, that can be provided to the master switch 104 and published to each of the other switches 108 of the network 100 to control server load balancing.

FIG. 3 is a block diagram illustrating an example architecture for the master switch 104. The switch 104 of FIG. 3 comprises a processing device 300, memory 302, and multiple ports 1-n, each of which is connected to a local interface 304.

The processing device 300 can comprise a microprocessor that is configured to execute instructions stored in memory 302 of the switch 104. Alternatively or in addition, the processing device 300 can include one or more application specific integrated circuits (ASICs). The memory 302 comprises one or more nonvolatile memory elements, such as solid-state memory elements (e.g., flash memory elements). Although nonvolatile memory elements have been specifically identified, the memory 302 can further or alternatively comprise volatile memory. The various ports 1-n are used to send network packets from the switch 104 and receive network packets from other devices, such as the router 102 and the access switches 108 shown in FIG. 1.

As indicated in FIG. 2, stored in memory 302 is a basic operating system 306 that comprises the instructions that control the general operation of the switch 104. In addition, stored in memory 302 is an SLB controller 308 that comprises a protocol generator 310 and one or more network traffic tables 312. Like the SLB controller 214, the SLB controller 308 is configured to control server load balancing. In some embodiments, the SLB controller 308 receives server load balancing algorithms from the SLB controller 214 of the master server 110a and converts the algorithms into protocol that can be published to and implemented by each of the other switches 108 of the network 100 (FIG. 1). In other embodiments, the SLB controller 308 receives the availability information from the application servers 110, generates server load balancing algorithms on its own, and publishes the appropriate protocol to the other switches 108. To provide for redundancy, the algorithms, whether received or generated by the SLB controller 308, can be sent from the master switch 104 to the backup master switch 106.

The network traffic tables 312 can be used to track the traffic that is being processed by the application servers 110. In some embodiments, the network traffic tables 312 are used to track open traffic flows that have been established between clients and the application servers 110. As described below, knowledge of such flows facilitates the determination made by the switches as to which application server is to receive given network packets.

Various programs (i.e. logic) have been described herein. The programs can be stored on any computer-readable medium for use by or in connection with any computer-related system or method. In the context of this document, a computer-readable medium is an electronic, magnetic, optical, or other physical device or means that contains or stores a computer program for use by or in connection with a computer-related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Example systems having been described above, operation of the systems will now be discussed. In the discussions that follow, flow diagrams are provided. Process steps or blocks in the flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

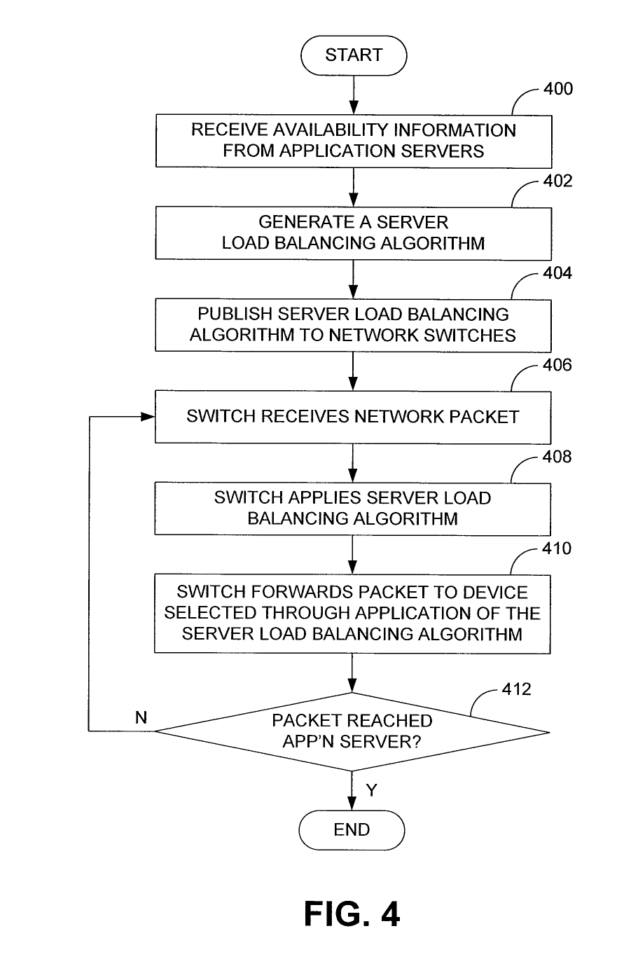

FIG. 4 illustrates an overview of an example method for server load balancing. More particularly, illustrated in FIG. 4 an example for publishing a server load balancing algorithm and implementing the algorithm in relation to a single network packet. Beginning with block 400 of FIG. 4, availability information is received from application servers of a designated server group or farm. In some embodiments, the availability information is binary, i.e., the application server is either available or unavailable to receive workload. In cases in which unavailability is due to a crash or overload, availability information may only be received from the available application servers such that the only information received is information indicating a server's capability to receive and process network traffic.

The device that receives the server availability information can depend upon the configuration of the system. In embodiments in which a master server is used, the availability information can be received by the master server. In embodiments in which the master server is not used, the availability information can be received by the master switch. In either case, a server load balancing algorithm can be generated (i.e., created or selected), as indicated in block 402, relative to the received availability information. As described in greater detail below, the server load balancing algorithm is configured to distribute workload across the available servers of the group in a randomized manner such that each available server receives approximately the same amount of workload. For example, if five application servers of the group indicated their availability, the server load balancing algorithm would ensure that approximately ⅕ of the network traffic is directed to each of the five servers. As is also described in greater detail below, the server load balancing algorithm can be applied relative to one or more fields of each packet that is to be controlled. Such fields can comprise, for example, the source address (e.g., a layer 2 or a layer 3 address), the destination address field (e.g., a layer 2 or a layer 3 address), and the application type.

As with reception of the server availability information, the device that generates the load balancing algorithm can depend upon the particular network configuration. In embodiments in which a master server is used, the server load balancing algorithm can be generated by the master server. In embodiments in which the master server is not used, the server load balancing algorithm can be generated by the master switch.

Turning to block 404, the load balancing algorithm is published to the switches of the network. Such publication can be performed either by the master server or the master switch. Regardless, the algorithm, or a related protocol that can be implemented by the switches, is provided to the switches such that they are configured to make server load balancing determinations through application of the algorithm. The following discussion describes such server load balancing in relation to a single network packet for purposes of explanation.

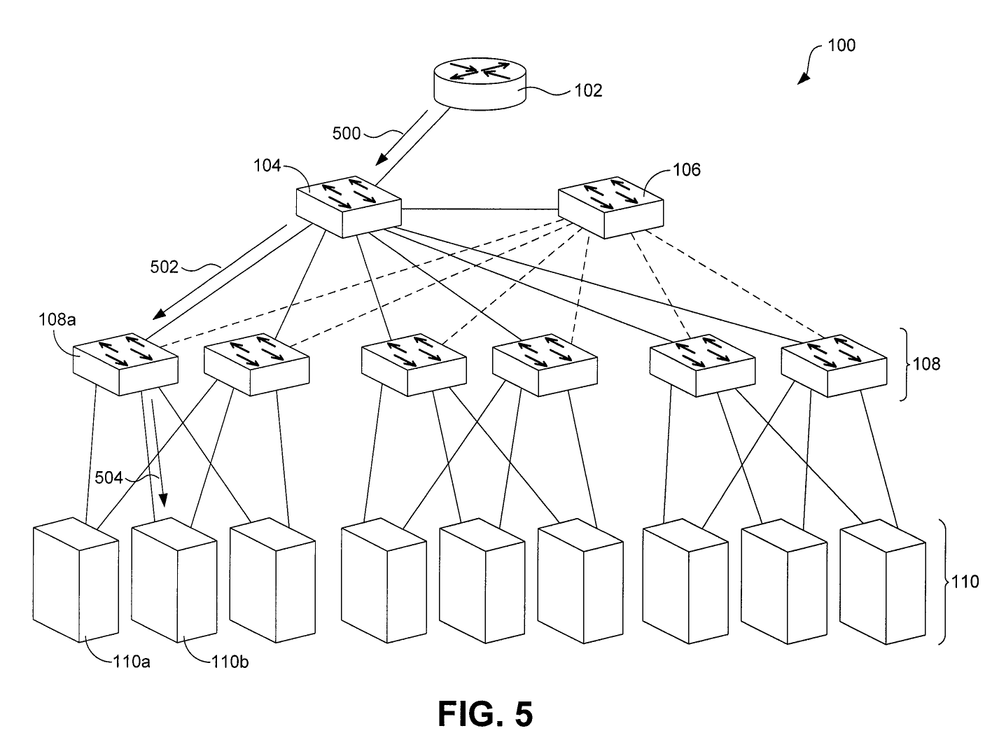

Referring to block 406, a switch receives a network packet. For purposes of example, the switch may comprise the master switch 104. Such a scenario is depicted in FIG. 5, in which an arrow 500 identifies transmission of the packet from the router 102 to the master switch 104. With reference next to block 408 of FIG. 4, the switch (e.g., master switch 104) applies the server load balancing algorithm to the packet. Through such application, the switch determines what device to which to forward the packet. When the switch is the master switch 104, the device to which the packet will be forwarded comprises one of the access switches 108. The switch then forwards the packet to the selected device, as indicated in block 410. In the example of FIG. 5, the master switch 104 selected access switch 108a through application of the algorithm, as indicated by arrow 502.

Returning to FIG. 4, the process from this point depends upon whether the packet has reached an application server, as indicated in decision block 412. Assuming it has not, for example the master switch 104 forwarded the packet to the access switch 108a (FIG. 5), flow returns to block 406 at which a switch, this time the access switch 108a, receives the packet, applies the server load balancing algorithm (block 408), and forwards the packet to a selected device (block 410). In the example of FIG. 5, the access switch 108a has selected application server 110b as the device to receive the packet, as indicted by arrow 504. The packet therefore reaches an application server (block 412) and the process is terminated for that particular packet. Of course, a similar process would be performed in relation to other packets that are received from the router 102.

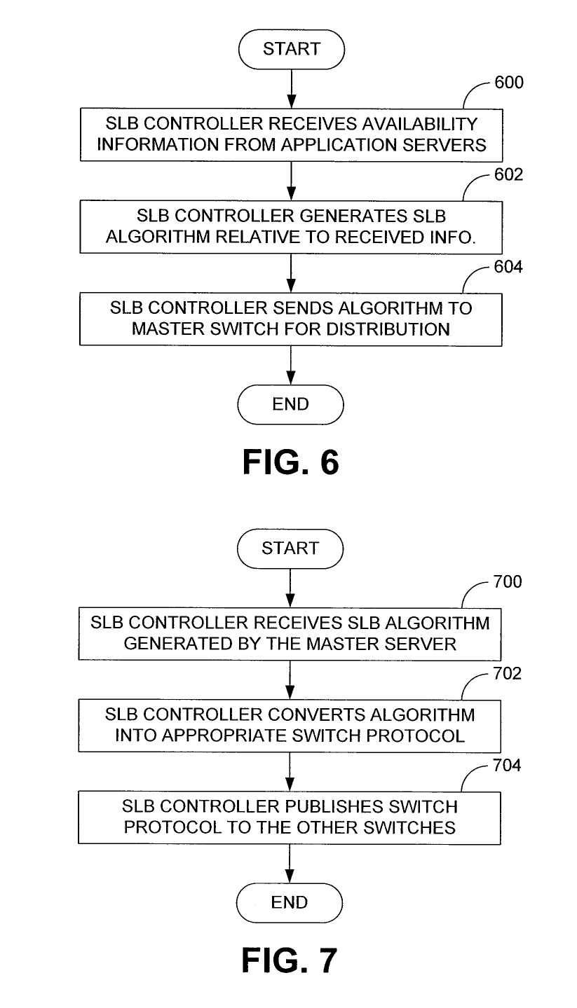

FIG. 6 is a flow diagram that illustrates an embodiment of operation of the SLB controller 214 of the master server 110a of FIG. 2. Beginning with block 600, the SLB controller 214 receives availability information from application servers of a designed server load balancing group or farm. Notably, the server availability information can be sent to or collected by the SLB controller 214 on a periodic basis. In such a scenario, an application server that fails to signal its availability within a predetermined period of time may be assumed by the SLB controller 214 to have become unavailable. The SLB controller 214 can then remove the application server from a list of available servers that it maintains and can take the server's unavailability into account in generating a sever load balancing algorithm. It is further noted that if availability information is received from a new application server, i.e., a server not currently contained with the list, the SLB controller 214 can add the server to the list after appropriate authentication measures are taken.

With reference next to block 602, the SLB controller 214 generates the server load balancing algorithm. By way of example, the algorithm is generated by the SLB algorithm generator 216 shown in FIG. 2. As described above, the algorithm can comprise an algorithm that results in random selection of a device. By way of example, the algorithm comprises a hashing algorithm that can perform a mathematical function on one or more fields of the received network packets. Alternatively, the algorithm can comprise a “round robin” algorithm in which each one of a group of available devices is selected sequentially. In either case, the algorithm will operate to select recipient devices generally an equal number of times so as to substantially equally distribute the network traffic.

Turning to block 604, the SLB controller 214 sends the generated algorithm to the master switch 104 for distribution.

FIG. 7 is a flow diagram that illustrates an embodiment of operation of the SLB controller 308 of the master switch 104 of FIG. 3. Beginning with block 700, the SLB controller 308 receives the server load balancing algorithm generated by the master server. With reference to block 702, the protocol generator 310 of the SLB controller 308 then converts the algorithm into a switch protocol appropriate for implementation by the other switches of the network, such as access switches 108 shown in FIG. 1.

Next, the SLB controller 308 publishes the switch protocol to the other switches, as indicated in block 704, so that those switches can implement the protocol and make appropriate determinations themselves as to where to forward received network packets.

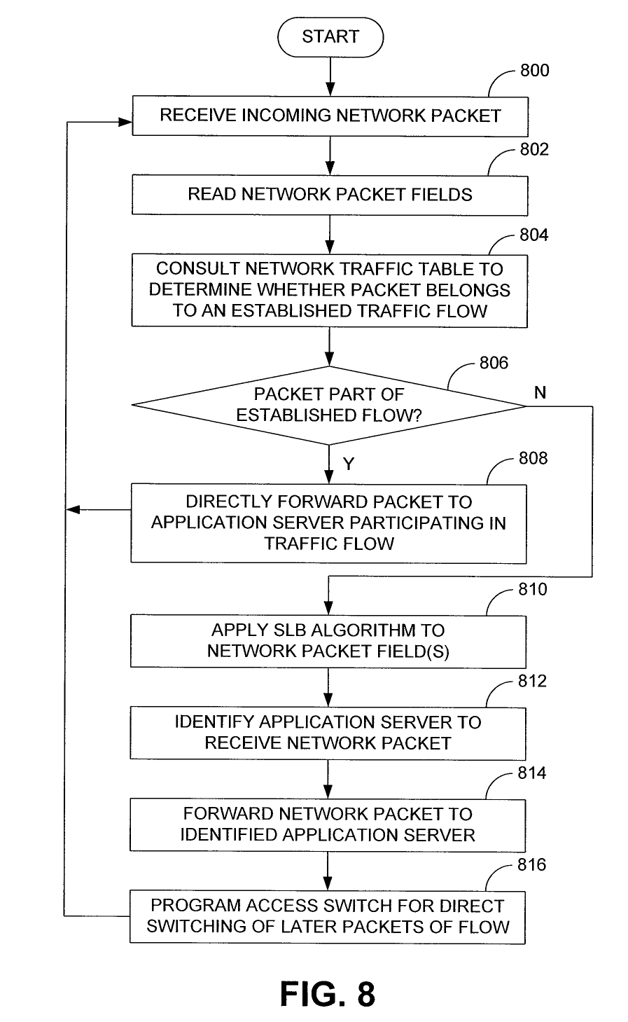

FIG. 8 is a flow diagram that illustrates an embodiment of an access switch, such as an access switch 108 shown in FIG. 1, performing server load balancing. Beginning with block 800, the access switch receives an incoming network packet. The access switch then reads the network packet fields, as indicated in block 802. By way of example, each of those fields is contained in a header of the network packet. Referring next to block 804, the access switch uses information contained one or more of the fields to consult a network traffic table and determine whether the packet belongs to an established network flow. By way of example, the access switch looks for a matching five-tuple (source port, destination port, source address, destination address, protocol) of the packet in the network traffic table.

With reference next to decision block 806, the process from this point depends upon whether the packet is or is not part of an established traffic flow. If so, the process continues to block 808 at which the packet is directly forwarded to the application server participating in the identified traffic flow. By way of example, such forwarding can be accomplished using a previously programmed ASIC. In this manner, a network packet that belongs to an established traffic flow can be immediately forwarded to the appropriate application server without application of the current server load balancing algorithm. If, on the other hand, the packet is not part of an established traffic flow, the process continues to block 810 at which the current server load balancing algorithm is applied to one or more of the packet fields. As described above, the server load balancing algorithm can comprise a hashing algorithm that is applied to one or more of the source address, the destination address, and the application type. Through such application, a random selection results.

Referring next to block 812, the access server identifies the application server to receive the network packet based upon the result of the application of the server load balancing algorithm. The access server can then forward the network packet to the identified application server, as indicated in block 814, such that the application server can process the packet. To take advantage of the direct forwarding described in relation to block 808 above, the access switch can further program itself (e.g., an ASIC) for direct switching of later packets (block 816) that belong to the same traffic flow as the packet that was forwarded in block 814.

At that point, the process can return to block 800 at which the access switch receives a new network packet. Notably, should the availability of one or more of the application servers change during the course of such operation, a new algorithm (or appropriate protocol associated therewith) can be provided to the access switch. In such a case, the new algorithm (or protocol) replaces the previous algorithm (or protocol) and will control the manner in which the access switch directs the network traffic it receives.

From the above, it can be appreciated that the systems and methods described herein provide an implementation that does not require complex and expensive equipment. Instead, each switch of the network is leveraged to make a distribution decision based on the application of a relatively simple algorithm. In addition, the computational power of the application servers is not taxed given that each server only receives packets that it is supposed to process.

Although various embodiments of systems and methods for network packet capture have been described herein, those embodiments are mere example implementations of the disclosed systems and methods. Therefore, alternative embodiments are possible, each of which is intended to fall within the scope of this disclosure.

The following are claimed:

1. A method for server load balancing within a network, the method comprising:
generating a server load balancing algorithm configured to distribute workload across multiple application servers;
publishing the server load balancing algorithm to switches of the network; and
the switches applying the server load balancing algorithm to received network packets to determine how to distribute the network packets among the multiple application servers.

2. The method of claim 1, wherein the server load balancing algorithm is configured to substantially equally distribute workload across the multiple application servers.

3. The method of claim 1, wherein the server load balancing algorithm comprises a hashing algorithm that produces randomized results.

4. The method of claim 1, wherein generating a server load balancing algorithm comprises a master server of the network generating the server load balancing algorithm.

5. The method of claim 4, further comprising the master server sending the server load balancing algorithm to a master switch of the network for distribution to other network switches.

6. The method of claim 1, wherein generating a server load balancing algorithm comprises a master switch of the network generating the server load balancing algorithm.

7. The method of claim 1, wherein publishing the server load balancing algorithm to switches of the network comprises a master switch publishing the server load balancing algorithm to the other switches.

8. The method of claim 1, wherein the switches applying the server load balancing algorithm comprises the switches applying a hashing algorithm to information contained in a field of each network packet to be forwarded.

9. The method of claim 8, wherein the switches applying a hashing algorithm comprises the switches applying the hashing algorithm to one of a source address, a destination address, or an application type of each network packet.

10. A server load balancing system stored on a computer-readable medium, the system comprising:
logic configured to generate a server load balancing algorithm configured to distribute workload across multiple application servers;
logic configured to publish the server load balancing algorithm to switches of the network; and
logic configured to cause a network switch to apply the server load balancing algorithm to received network packets to determine how to distribute the network packets among the multiple application servers.

11. The system of claim 10, wherein the server load balancing algorithm is configured to substantially equally distribute workload across the multiple application servers.

12. The system of claim 10, wherein the server load balancing algorithm comprises a hashing algorithm that produces randomized results.

13. The system of claim 10, wherein the logic configured to cause a network switch to apply the server load balancing algorithm comprises logic configured to cause the network switch to apply a hashing algorithm to information contained in a field of each network packet to be forwarded.

14. The system of claim 13, wherein the logic configured to cause the network switch to apply a hashing algorithm comprises logic configured to cause the network switch to apply the hashing algorithm to one of a source address, a destination address, or an application type of each network packet.

15. A network switch configured to perform server load balancing, the switch comprising:
a processing device;
multiple nodes that can forward or receive network packets; and
memory that comprises a server load balancing algorithm that can be executed by the processing device, the server load balancing algorithm being configured to randomly select application servers to which to forward network packets from the nodes such that a substantially equal amount of network traffic is received and processed by each application server over time.

16. The network switch of claim 15, wherein the server load balancing algorithm comprises a hashing algorithm that the network switch applies to a field of each received network packet.

17. The network switch of claim 16, wherein the network switch applies the hashing algorithm to information contained in one of a source address field, a destination address field, or an application type field.

18. The network switch of claim 15, wherein the memory further comprises a network traffic table that stores information about network traffic being processed by one or more of the application servers.

19. The network switch of claim 18, wherein the network switch is further configured to consult the network traffic table to determine whether received network packets comprise part of a previously established traffic flow and, if so, directly forward the network packets to the application server participating in the traffic flow.

20. The network switch of claim 15, wherein the network switch is further configured to generate the server load balancing algorithm.

21. The network switch of claim 20, wherein the network switch is configured to generate the server load balancing algorithm relative to availability information received from the application servers.

22. The network switch of claim 15, wherein the network switch is further configured to publish the server load balancing algorithm to other network switches.

23. The network switch of claim 15, wherein the network switch is further configured to receive the sever load balancing algorithm from a master server and publish the server load balancing algorithm to other network switches.
